(19) United States
(12) Patent Application Publication
(10) Pub. No.: US 2011/0111185 A1
(43) Pub. Date: May 12, 2011

(54) SOLID INK T-SHIRT TRANSFERS

(75) Inventor: Oliver Edward I'Anson Banks, Welwyn Garden City (GB)

(73) Assignee: XEROX CORPORATION, Norwalk, CT (US)

(21) Appl. No.: 12/614,712

(22) Filed: Nov. 9, 2009

(51) Int. Cl. B32B 3/10; B32B 38/14

(52) U.S. Cl. 428/195.1; 156/277

(57) ABSTRACT

An apparatus for transferring indicia onto a medium is disclosed. The apparatus includes a substrate, and a mirror image of an image pattern printed onto the substrate with a phase-change ink having a phase-change temperature on a first side of the substrate, the printed mirror image configured to change phase and transfer to a medium in response to the first side of the substrate being placed in contact with a first side of the medium and sufficient heat applied to a second side of the substrate to raise the temperature of the phase-change ink of the mirror image to the phase-change temperature.

### TECHNICAL FIELD

The devices and methods disclosed below generally relate to transferring an image onto a medium and particularly to transferring an image to a garment.

### BACKGROUND

Different methods have been developed to transfer images onto a medium such as an article of clothing. In U.S. Pat. No. 4,066,802 to Clemens a xerographic image transfer process is disclosed. FIG. 3 of the '802 patent, reproduced here and titled as FIG. 7, depicts an apparatus for transferring an image to a shirt. Toner material is placed on a substrate coated with an abhesive release material. The abhesive release material overlaying the substrate may be formed of any material which exhibits release properties to resins forming toner and a plasticizing layer. A polymeric interposed sheet is placed on the toner material to form a composite. A medium such as an article of clothing is then brought in contact with the composite and heat and pressure are applied. Application of heat and pressure to the composite by way of heating elements in lower and upper platens of a press causes an adherence of the toner material to the medium.

The process of the '802 patent requires the presence of a polymeric interposed sheet to facilitate a permanent adherence of the toner material to the medium. Inclusion of the interposed sheet adds cost to the process of transferring an image to a T-shirt. In addition, the presence of an interposed sheet in areas where there is no toner can produce an esthetically unpleasing effect as well as a degree of un-comfortableness for the wearer of the garment, especially when the material of the garment is thin. Furthermore, the permanence of adherence of the toner material to the medium is dependent on the interposed sheet. The adherence may degrade over time result in the peeling of the toner material.

### SUMMARY

An apparatus for transferring indicia onto a medium is disclosed. The apparatus includes a substrate, and a mirror image of an image pattern printed onto the substrate with a phase-change ink having a phase-change temperature on a first side of the substrate, the printed mirror image configured to change phase and transfer to a medium in response to the first side of the substrate being placed in contact with a first side of the medium and sufficient heat applied to a second side of the substrate to raise the temperature of the phase-change ink of the mirror image to the phase-change temperature.

A method for making a transferable image is also disclosed. The method includes printing a mirror image of an image pattern with a phase-change ink having a phase-change temperature onto a first side of a substrate, and applying a removable protective layer over the first side of the substrate.

### BRIEF DESCRIPTION OF THE DRAWINGS

The foregoing aspects and other features of the present disclosure are explained in the following description, taken in connection with the accompanying drawings.

FIG. 1 is a perspective view of an image transferring apparatus with an image pattern to be transferred to a medium printed on a substrate and the substrate placed on the medium.

FIG. 2 is a perspective view of the substrate showing a mirror image of the image pattern printed on a first side of the substrate with the corner of the substrate folded back to reveal a second side of the substrate.

FIG. 3 is a schematic of components used in one embodiment to print an image pattern on a substrate and cover it with a protective layer.

FIG. 4 is a plan side view of a process for transferring the image pattern on the substrate of FIG. 3 onto a medium.

FIG. 5 is a plan side view of the phase-change ink settling onto the first side of the medium.

FIG. 6 is a plan side view of the phase change ink reconstituted on the first side of the medium.

FIG. 7 is cross sectional view of an image transfer apparatus according to the prior art.

### DETAILED DESCRIPTION

The term “printer” as used herein refers, for example, to reproduction devices in general, such as printers, facsimile machines, copiers, and related multi-function products. While the specification focuses on a web transport system that controls the transport of a web under a series of print heads, the transport system may be used with any web transport system that transports a web from one location to another. Furthermore, the device and method described herein may be used with printers that form printed images with either aqueous ink, phase change ink, or gel ink, as described below.

The term “medium” as used herein refers, for example, to an article of clothing such as a T-shirt as well as to other image receiving surfaces such as a painter's canvas.

The term “phase change ink” encompasses inks that remain in a solid phase at an ambient temperature and that melt into a liquid phase when heated above a threshold temperature, referred to as a phase-change temperature.

The terms “gel ink” or “gel-based ink” encompass inks that remain in a gelatinous state at the ambient temperature and that may be altered to have a different viscosity suitable for ejection by a print head. In particular, gel ink in the gelatinous state may have a viscosity between 105 and 107 centipoise (“cP”); however, the viscosity of gel ink may be reduced, to a liquid-like viscosity, by heating the ink above a threshold temperature, referred to as a gelation temperature. An exemplary range of gelation temperatures is approximately thirty to fifty degrees Celsius; however, the gelation temperature of some types of gel ink may be above or below the exemplary temperature range.

Some inks, including gel inks, may be cured during the printing process. Radiation curable ink becomes cured after being exposed to a source of radiation. Suitable radiation may encompass the full frequency (or wavelength) spectrum, including but not limited to, microwaves, infrared, visible, ultraviolet, and x-rays. In particular, ultraviolet-curable gel ink, referred to herein as UV gel ink, becomes cured after being exposed to ultraviolet radiation.

The term “substrate” as used herein refers, for example, to a sheet on first side of which a mirror image of an image pattern is printed. The sheet is a temporary carrier of the phase-change ink and is used for transferring the image pattern to the medium.

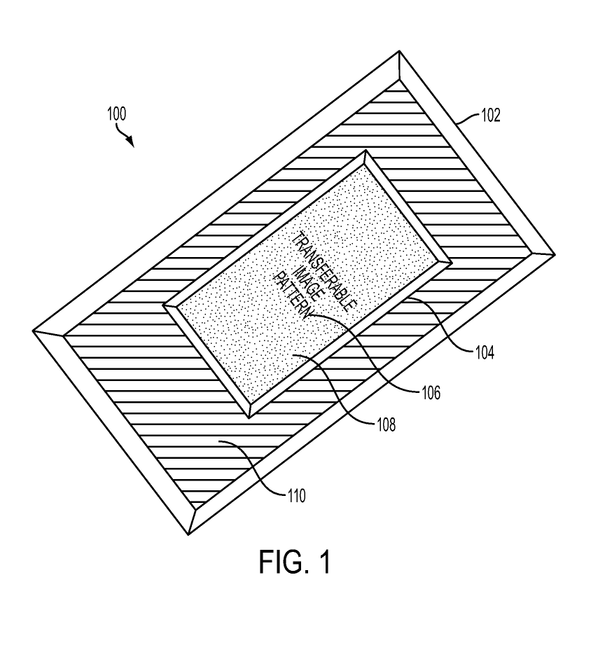

Referring to FIG. 1, an image transfer system 100 is depicted. A medium 102 having a first side 110 receives a substrate 104 having a second side 108 with an image pattern 106 to be transferred to the medium 102, the image pattern 106 being visible through the substrate 104. Although the substrate 104 is depicted as a semi-translucent layer, the substrate 104 can be opaque in which case the image pattern 106 is not visible through the substrate 104. The substrate 104 is chosen from a material that is well suited for heat conduction. In one embodiment the substrate 104 is nonporous. An example of a suitable substrate material is a glossy paper with the second side 108 of the substrate 104 being a non-glossy side. As depicted in FIG. 1, the image pattern 106 is a pattern that is shown in an orientation that is to be transferred to the first side 110 of the medium 102. That is, and as will be described in greater detail below, at the end of an image transfer process, upon removal of the substrate 104 from the medium 102, the image pattern 106 permanently remains on the first side 110 of the medium 102 in the orientation of the image pattern 106 that is depicted in FIG. 1.

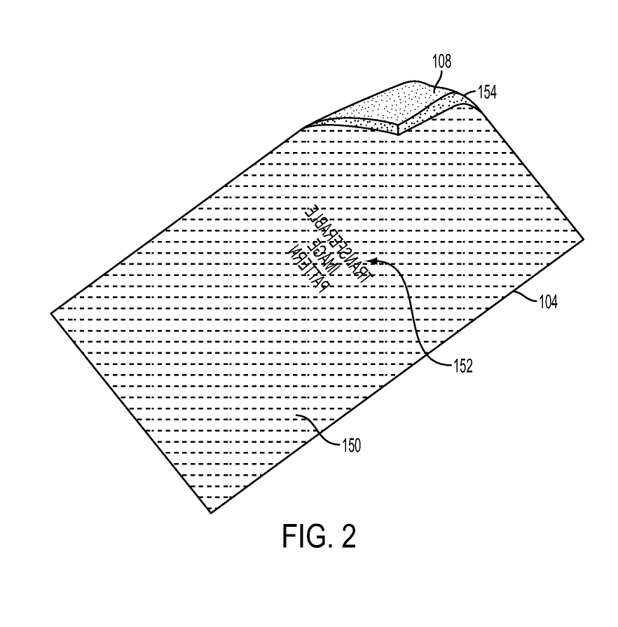

In order to transfer the image pattern 106 to the medium 102, a mirror image pattern 152 of the image pattern 106 is first printed onto a first side 150 of the substrate 104, with a phase change ink as depicted in FIG. 2. The upper right corner of the substrate is folded over to reveal the second side 108 of the substrate 104. The substrate 104 as depicted has a thickness 154. In one embodiment, the thickness 154 can range from about 0.1 mm to about 0.5 mm. The substrate 104 can range from a thin paper that is discarded after a single use to a thicker substrate suitable for multiple uses. As discussed above, the first side 150 of the substrate can be a non-porous surface suitable for easy release of the phase change ink, when the substrate is heated as will be discussed in greater detail below. In one embodiment, the thickness of the printed phase-change ink on the first side 150 of the substrate 104 is about 0.1 mm. However, thinner phase-change ink is also envisioned to achieve lighter colors.

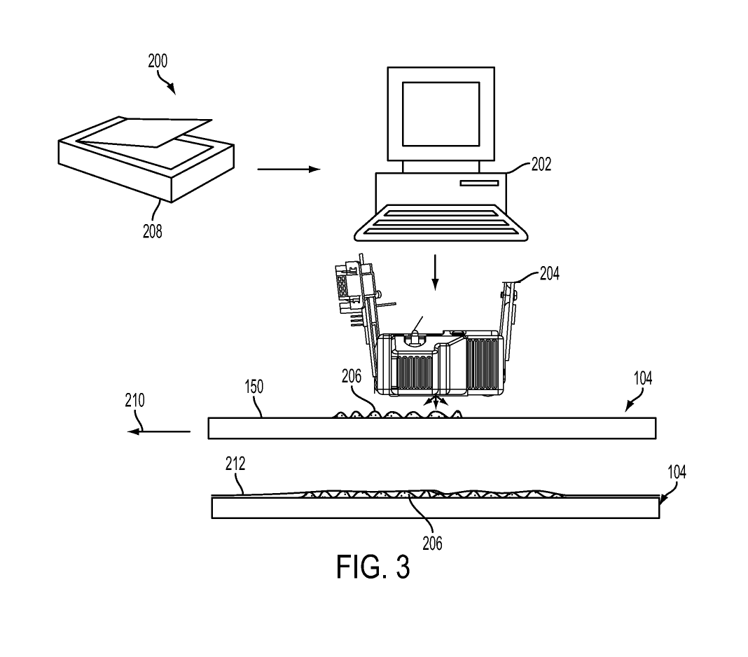

Referring to FIG. 3, an image capture and processing system 200 is depicted. An image of the image pattern 106 can be captured using a scanner 208, which can be in electronic communication with a computing device 202. The image is stored in the memory of the computing device 202 and processed to generate an electronic version of a mirror image of the image. Also, firing signals are generated for a print head 204 by the computing device 202. Upon receiving the firing signals the print head 204 melts the phase-change ink and ejects the liquid ink onto the first side 150 of the substrate 104 as the substrate and the print head 204 are moving relative to each other as indicated by the arrow 210. The reconstituted ink 206 forms the mirror image pattern 152 on the first side 150 of the substrate 104. The term “reconstituted ink” refers to a phase-change ink that has changed phase from a first phase to a second phase and back to the first phase. For example, a solid ink which is initially solid (first phase) can be melted into a liquid phase (second phase) for ejection out of a print head. Once the liquid ink is ejected onto the substrate and cools back to a solid phase (first phase), the solid ink is considered as having reconstituted.

In one embodiment the substrate 104 can be cooled to below the ambient temperature prior to the print head 204 ejecting the phase-change ink onto the first side of 150 of the substrate 104. Pre-cooling the substrate 104 assists in quickly reconstituting the molten ink into a solid ink. A sharper image can result especially at the edges of the mirror image pattern 152. In one embodiment a gel ink can be used in place of a phase-change ink. The gel ink can be cured by using radiation curing by for example an ultraviolet light. In one embodiment a protective layer 212 can be placed over the reconstituted ink 206 to protect the ink during handling. The protective layer 212 can be any material that does not disturb the reconstituted ink 206 when the protective layer 212 is peeled off prior to placement of the substrate 104 on the first side 110 of the medium 102. In one embodiment, multiple colored phase-change inks can be used in connection with several print heads, i.e., one print head per color. Where multiple colored phase-change ink are used to generate a colored image, the computing device 202 processes the captured image from the scanner 208 to generate multiple mirror images as well as firing signals for multiple print heads. Each mirror image corresponds to a different color of the phase-change ink which is associated with a different print head for that color. Not shown in FIG. 3, and in accordance with one embodiment, is a pressing operation which includes pressing mandrels to affix the phase change ink to the first side 150 of the substrate 104 by passing the substrate 104 with reconstituted ink 206 on the first side 150 through the pressing mandrels.

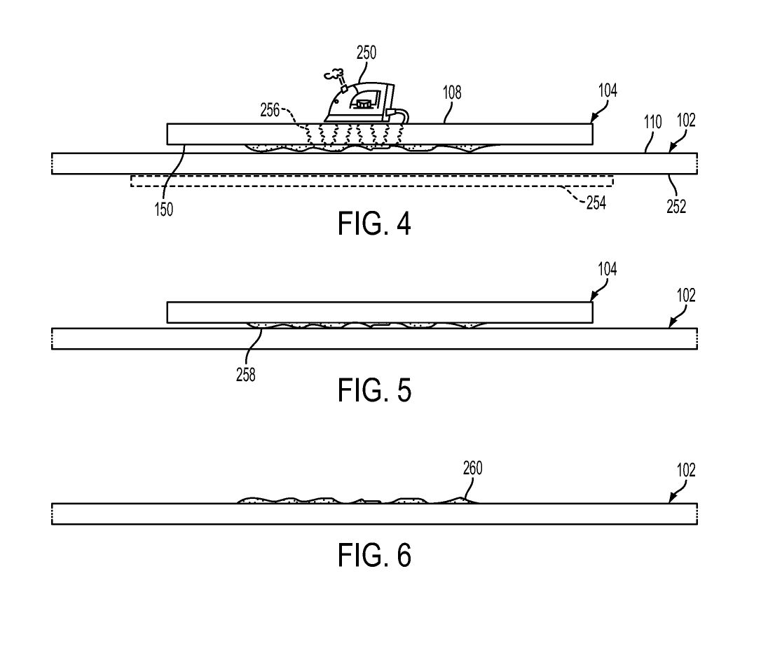

Referring to FIG. 4, a process of transferring the image pattern 106 from the substrate 104 to the first side of the medium 110 is depicted. Prior to placing the substrate 104 on the medium 102, the protective layer 212 is removed if the protective layer 212 was attached to the substrate 104 as depicted in FIG. 3. A heat applicator 250 applies heat to the second side 108 of the substrate 104. Application of heat causes the reconstituted phase-change ink 206 to melt. In one embodiment a sealing layer 254 is placed under the medium and in contact with a second side 252 of the medium 102. The sealing layer 254 absorbs excess phase-change ink that may seep through the medium when the phase-change ink is heated and is melted. In the embodiment where a glossy paper is used as a substrate 104, the glossy side is configured to withstand the heat applied to the substrate 104, and therefore remains inert to the phase-change ink.

In addition to heat designated by reference numeral 256, pressure can also be applied to increase the pace of phase change. Also, pressure can be used to enhance the adherence of the phase change ink to the first side 110 of the medium 102 as it reconstituting from a liquid phase to a solid phase. In one embodiment, pressure in the range of about 0.01 bars to about 0.02 bars is applied to the second side 108 of the substrate 104.

Referring to FIG. 5, the phase-change ink is shown in a phase between a solid phase and a liquid phase as the reconstituted ink 206 melts from the first side 150 of the substrate and begins to reconstitute on the first side 110 of the medium 102. In one embodiment, application of heat to the second side 108 of the substrate 104 causes the temperature of the first side 150 the substrate 104 to reach between about 50° C. and about 100° C. In another embodiment, the temperature of the first side 150 of the substrate 104 can reach to between about 80° C. and about 90° C.

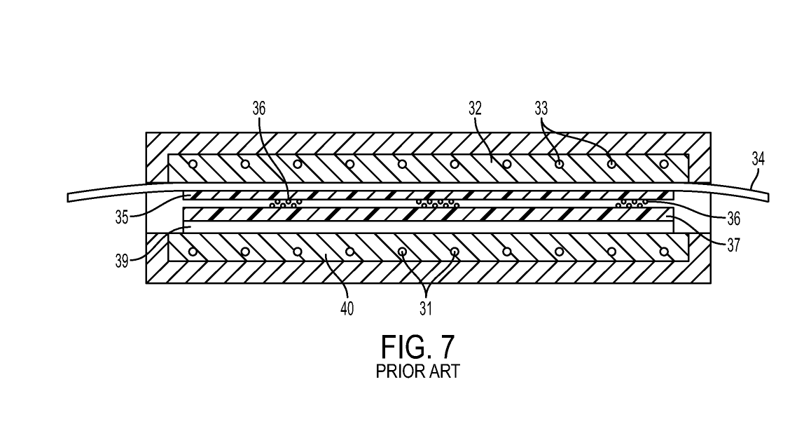

Referring to FIG. 6, the phase change ink is depicted in a reconstituted manner on the first side 110 of the medium 102. The image pattern 106 reconstitutes on the first side 110 of the medium. The reconstituted ink is permanently affixed to the medium 102 and can withstand numerous wash and dry cycles. In one embodiment, a secondary pressing operation may result in a further enhanced image quality once the ink has reconstituted on the medium 102.

In embodiments where multiple colored phase-change inks are used, each colored phase change ink changes phase and reconstitutes according to a corresponding phase-change temperature. Volume of the phase-change ink per unit area ejected from the print head 204 is an important aspect. Too much ink may cause a bleeding effect between boundaries defining features in the image, resulting in a less sharp image. This bleeding effect can be particularly problematic in colored images, where too much ink can result in one color of phase-change ink to bleed into another color of phase-change ink when reconstituting on the first side 110 of the medium 102. While in the case of a single colored image, too much ink may result in a lessening of the sharpness of the image, in a colored image, too much phase-change ink can result in an undesirable color bleeding between regions of differing colors. Too little phase-change ink can result in a faded image, or potentially in a blotchy image.

It will be appreciated that various of the above-disclosed and other features, and functions, or alternatives thereof, may be desirably combined into many other different systems or applications. A few of the alternative implementations may comprise various combinations of the methods and techniques described. Various presently unforeseen or unanticipated alternatives, modifications, variations, or improvements therein may be subsequently made by those skilled in the art, which are also intended to be encompassed by the following claims.

1. An apparatus for transferring indicia onto a medium, comprising:
a substrate; and
a mirror image of an image pattern printed onto the substrate with a phase-change ink having a phase-change temperature on a first side of the substrate, the printed mirror image configured to change phase and transfer to a medium in response to the first side of the substrate being placed in contact with a first side of the medium and sufficient heat applied to a second side of the substrate to raise the temperature of the phase-change ink of the mirror image to the phase-change temperature.

2. The apparatus of claim 1, wherein the substrate is non-porous.

3. The apparatus of claim 1, further comprising:
a sealing layer in contact with a second side of the medium and configured to absorb phase-change ink that seeps through the medium.

4. The apparatus of claim 1, the mirror image includes a plurality of differently colored phase-change inks.

5. The apparatus of claim 1, wherein the phase-change temperature is in a range of about 50° C. to about 150° C.

6. The apparatus of claim 5, wherein the phase-change temperature is in a range of about 80° C. to about 90° C.

7. The apparatus of claim 1, wherein the substrate has a thickness in a range of about 0.1 mm to about 0.5 mm.

8. The apparatus of claim 1, wherein the phase-change ink has a thickness of about 0.1 mm.

9. The apparatus of claim 1, wherein a pressure of about 0.01 bars to about 0.02 bars is applied to the second side of the substrate to transfer the phase-change ink of the mirror image to the medium.

10. A method for making transferable image comprising:
printing a mirror image of an image pattern with a phase-change ink having a phase-change temperature onto a first side of a substrate; and
applying a removable protective layer over the first side of the substrate.

11. The method of claim 10 further comprising:
melting a phase-change ink;
supplying the melted phase-change ink to a print head; and
ejecting the melted phase-change ink from the print head onto the first side of the substrate to form the mirror image.

12. The method of claim 10 further comprising:
receiving data corresponding to the image pattern in a printing system;
modifying the data to generate data corresponding to the mirror image of the image pattern; and
using the modified data to generate firing signals that operate the print head to eject phase-change ink from the print head and form the mirror image on the substrate.

13. The method of claim 12 further comprising:
modifying the data to generate data corresponding to a plurality of mirror images of the image pattern, each mirror image of the image pattern corresponding to a different color of phase change ink.

14. The method of claim 13 further comprising:
using the modified data to generate firing signals that operate a plurality of print heads to eject a different colored phase-change ink from each print head and form the mirror image on the substrate.
